(19) United States
(12) Patent Application Publication
(10) Pub. No.: US 2017/0188568 A1
(43) Pub. Date: Jul. 6, 2017

(54) GAME CALL ASSEMBLY HAVING A PALATE CONFORMER

(71) Applicant: Outdoor Group Game Calls LLC, West Henrietta, NY (US)

(72) Inventors: Paul A. Vaicunas, East Amherst, NY (US); Nicholas D. Blodgett, Churchville, NY (US)

(73) Assignee: Outdoor Group Game Calls LLC, West Henrietta, NY (US)

(21) Appl. No.: 15/397,907

(22) Filed: Jan. 4, 2017

Related U.S. Application Data
(60) Provisional application No. 62/274,538, filed on Jan. 4, 2016.

(51) Int. Cl. A01M 31/00

(52) U.S. Cl. CPC A01M 31/004

(57) ABSTRACT

A game call assembly and method includes, in an embodiment, a mouth engager, a sound generator coupled to the mouth engager, and a palate conformer supported by the mouth engager.

### CROSS-REFERENCE TO RELATED APPLICATION

This application is a non-provisional of, and claims the benefit and priority of, U.S. Provisional Patent Application No. 62/274,538, filed on Jan. 4, 2016. The entire contents of such application are hereby incorporated by reference.

### BACKGROUND

Hunters are known to use game calls to attract animals. Some game calls, such as turkey and elk calls, are designed to be inserted entirely in the mouth. The hunter places such mouth call at the roof of his/her mouth. For proper sound generation, the hunter's exhaled air should flow along the bottom of the mouth call where its diaphragm is located.

However, depending upon the hunter, the mouth call may not fit the hunter's mouth roof. Each person has a uniquely shaped and sized mouth roof. The known mouth calls are not customizable. Therefore, the mouth call might fit for a hunter having a particular mouth roof shape and size, but that same call might not fit for other hunters having larger or smaller mouths or mouth roofs with different curvatures.

As a result, many hunters have one or more air passages that form between the roofs of their mouths and the top of the mouth call. Part of the hunter's exhaled air travels through these air passages instead of passing along the bottom of the game call. Consequently, the game call's diaphragm fails to generate the intended animal call or otherwise generates a hissing sound which is not an animal call.

In addition, poorly fitting mouth calls can create other problems. They can slide toward the throat, causing a gagging reflex or choking hazard. Also, they can cause mouth discomfort or pain due to the misfit.

The foregoing background describes some, but not necessarily all, of the problems, disadvantages and shortcomings related mouth game calls.

### SUMMARY

In an embodiment, the game call assembly includes: (a) a mouth engager having a top and a bottom; (b) a diaphragm holder coupled to the mouth engager; (c) a diaphragm held by the diaphragm holder; and (d) a palate conformer supported by the mouth engager. The palate conformer has a body, a plurality of ends, and a malleable characteristic. Due to the malleable characteristic, the palate conformer is configured to be changed from a first form to a second form. In the first form, the body and ends are positioned along a first axis. The first axis extends through a plurality of cheeks of a user when the palate confirmer is inserted into a mouth of the user. In the second form, the body is at least partially positioned along the first axis, and the ends are positioned on one or more axes other than the first axis. The one or more axes extend through the cheeks of the user when the palate conformer is inserted into the mouth of the user. When the body is in the second form, a portion of the mouth engager is configured to conform to, and be engaged with, a palate of the user's mouth so as to inhibit air from traveling between the palate and the top of the mouth engager so as to reduce a production of a sound not generated by the diaphragm.

In another embodiment, the game call assembly includes: (a) a mouth engager; (b) a sound generator coupled to the mouth engager; and (c) a palate conformer supported by the mouth engager. The palate conformer has a deformable characteristic.

Yet another embodiment includes or involves a method for manufacturing a game call assembly. The method includes: (a) providing a mouth engager; (b) coupling a sound generator to the mouth engager; (c) providing a deformable palate conformer; and (d) coupling the deformable palate conformer to a rear portion of the mouth engager. The deformable palate conformer is configured to be deformed so as to conform to a concave shape of a palate of a user.

Additional features and advantages of the present disclosure are described in, and will be apparent from, the following Brief Description of the Drawings and Detailed Description.

### BRIEF DESCRIPTION OF THE DRAWINGS

FIG. 1 is a bottom view of an embodiment of the game call assembly.

FIG. 2 is a top, interior view of an opened, partially-assembled form of the game call assembly of FIG. 1.

FIG. 3 is an exploded view of the game call assembly of FIG. 2.

FIG. 4 is an isometric view of an embodiment of the diaphragm holder illustrated in an unbent condition.

FIG. 5 is an isometric view of an opened, partially-assembled form of the game call assembly of FIG. 1.

FIG. 6 is a front view of an embodiment of the palate conformer in its initial shape.

FIG. 7 is a front view of the palate conformer of FIG. 6 in its final or bent shape.

FIG. 8 is a front, diagrammatic view of an embodiment of the game call assembly inserted into the mouth of a user, illustrating the palate conformer with the diaphragm holder removed.

FIG. 9 is a side, diagrammatic view of an embodiment of the game call assembly inserted into the mouth of a user, illustrating the diaphragm holder and the palate conformer.

### DETAILED DESCRIPTION

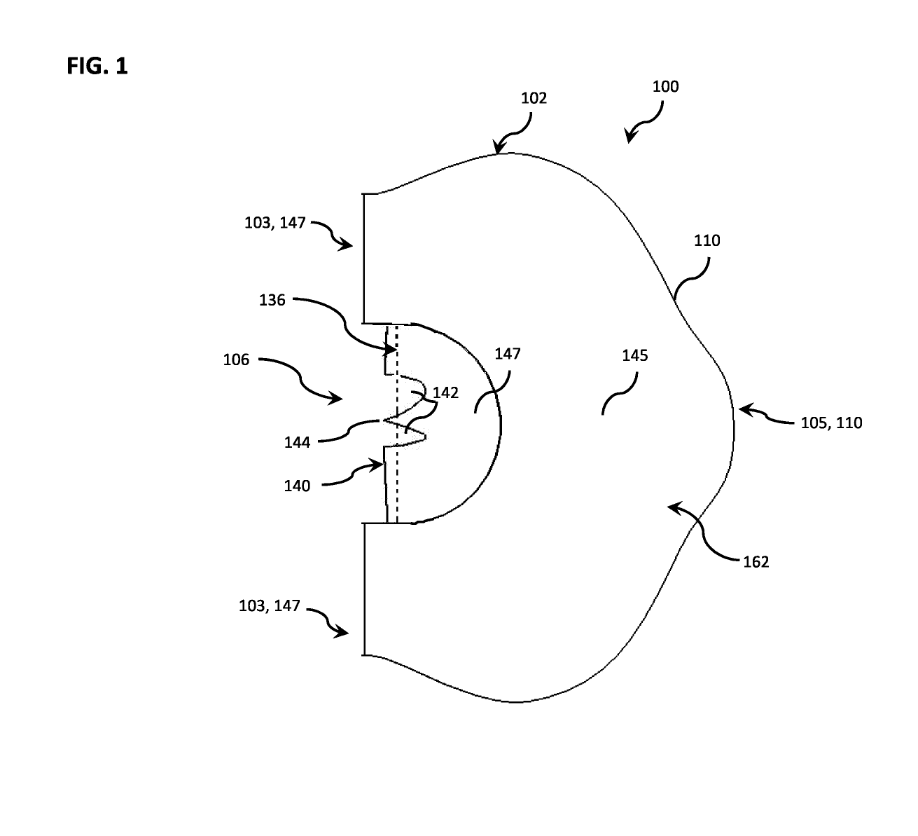

As illustrated in FIGS. 1-5, the game call assembly 100, in an embodiment, is configured to be inserted into the user's mouth as a mouth piece. In use, the user exhales air. As the air passes along the game call assembly 100, the game call assembly 100 generates a sound that simulates or resembles the actual sound of an animal, such as a turkey, elk, deer, moose, duck, goose or other game or prey. Accordingly, the game call assembly 100 functions as a decoy to lure animals for hunting purposes. In an embodiment, the game call assembly 100 includes: (a) a mouth engager 102; (b) a diaphragm holder 104 attached to the mouth engager 102; (c) a diaphragm 106 held by the diaphragm holder 104; and (d) a palate conformer 107 carried by the mouth engager 102. As described below, the game call assembly 100 eliminates, reduces or inhibits the undesirable production of extraneous sounds that are not generated by the diaphragm 106. Such extraneous, non-game call sounds, such as undesirable hissings sounds, can decrease the attraction of animals.

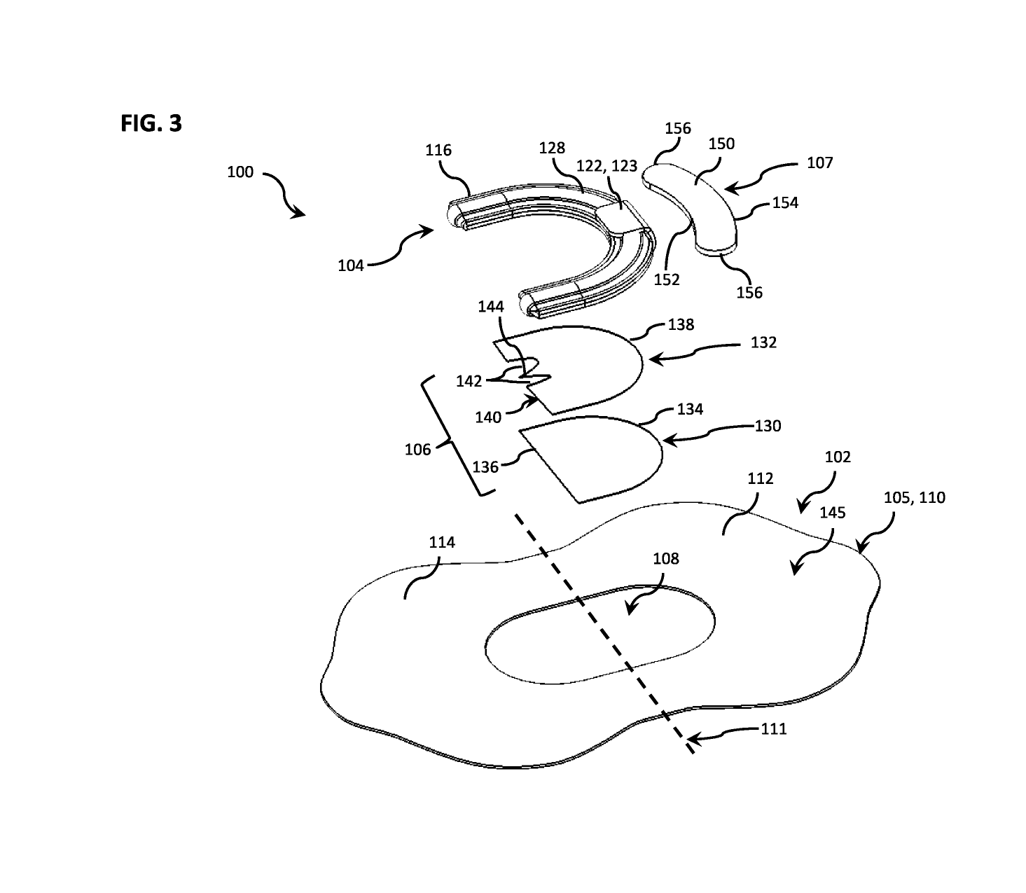

Referring to FIG. 3, the mouth engager 102, in an embodiment, is a substrate or a flexible layer of material defining an opening 108 configured to receive at least part of the diaphragm 106. The mouth engager 102 has a size and shape to enable the user to grasp the mouth engager 102, which assists with placing the game call assembly 100 in the user's mouth. In use, the user pinches the front end 103 and inserts the rear end 105 (FIG. 1) of the game call assembly 100 into the user's mouth. Once inserted, the mouth engager 102 provides an airflow sealing function, as described below.

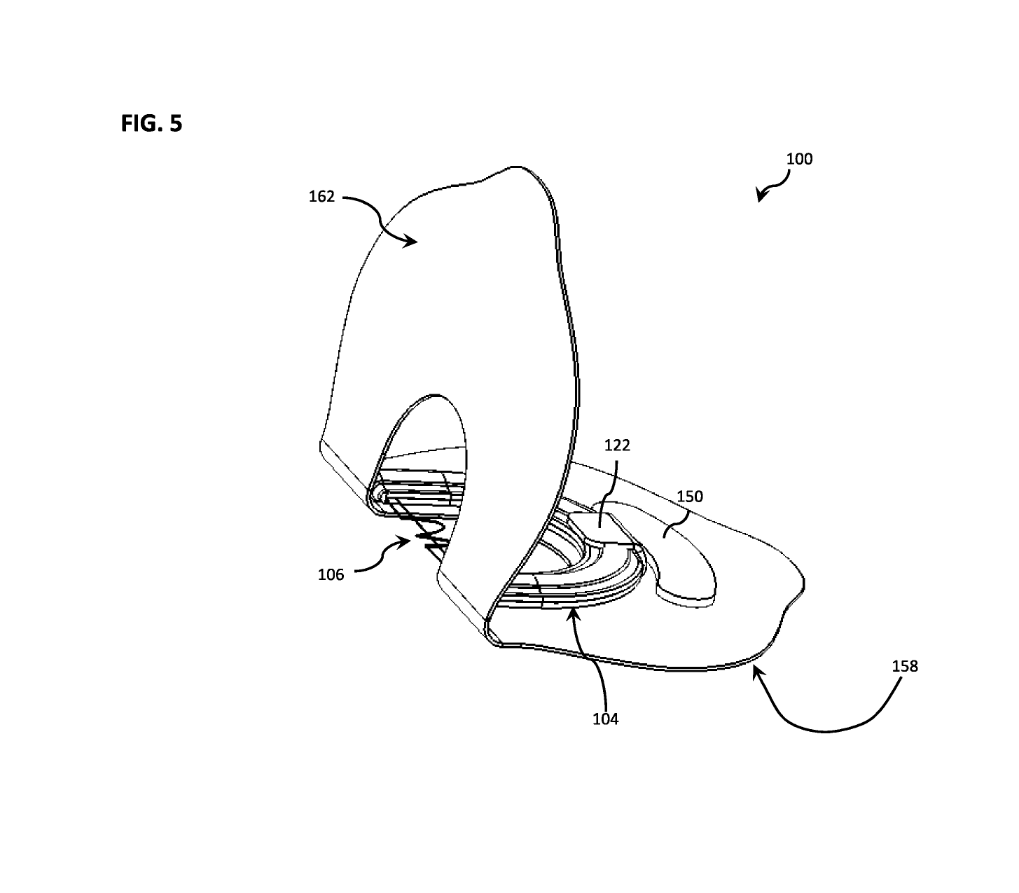

In an embodiment, the mouth engager 102 has a perimeter edge 110. The perimeter edge 110 generally conforms to the shape of the user's mouth. In the embodiment shown, the rear end 105 of the perimeter edge 110 has a peak or arc shape to facilitate sealing with the user's mouth roof or palate. As illustrated in FIGS. 3 and 5, in an embodiment, to form or manufacture the game call assembly 100, the manufacturer bends or folds the mouth engager 102 along foldline 111 (FIG. 3) in a clam fashion. An adhesive, such as a suitable glue, is then applied to one or more of the interior halves 112, 114. When the mouth engager 102 is fully folded and manufactured, as shown in FIG. 1, the adhesive holds the interior halves 112, 114 together. Alternatively, instead of adhesive, the halves 112, 114 could be heat-bonded, melted or otherwise fused or secured together using any suitable securement or fastener. In an embodiment, the mouth engager 102 is a layer of moisture-resistant, adhesive tape. It should be appreciated that the mouth engager 102 can be constructed of any suitable flexible or semi-flexible material.

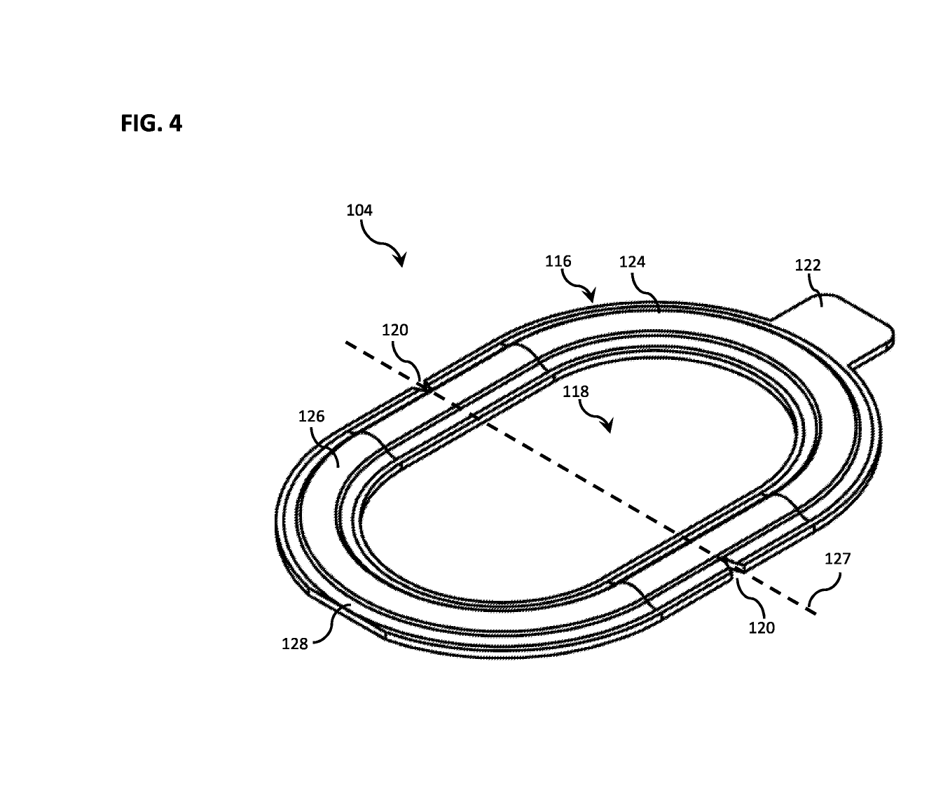

Referring to FIG. 4, the diaphragm holder 104 includes an oval frame 116 defining a frame opening 118. The frame 116 has a plurality of bend cut-outs or bend notches 120 and a holding tab 122 (e.g., a hook). During assembly, the diaphragm 106 is placed on the frame half 124. Next, the frame half 126 is folded at bendline or foldline 127 onto frame half 124, sandwiching diaphragm 106 (FIG. 1) between frame halves 124, 126. The bend notches 120 facilitate the bending or folding process and aid in locating the foldline 127 at the center of the frame 116. Then, the manufacturer bends the holding tab 122 into an L-shape 123 (FIG. 3) to hook and engage the end 128 of frame half 126. At this point, the folded frame 116 applies a pressure to the edge or perimeter 110 of diaphragm 106. This pressure is caused by the holding tab 122 and the material properties of the frame 116. As a result of this pressure, the frame 116 maintains a suitable tension within the reeds 130, 132 (FIG. 3) of diaphragm 106 for purposes of generating sound. As described below, in an embodiment, the diaphragm holder 104 is constructed of a suitable, bendable material.

As illustrated in FIG. 3, the diaphragm 106, in an embodiment, includes a plurality of flexible members or reeds 130, 132. In this embodiment, each reed 130, 132 is a relatively thin substrate or a flexible layer or membrane which flexes back and forth in response to air flow or air pressure. Depending upon the embodiment, each reed 130, 132 can be constructed of a relatively thin sheet of latex, rubber or other suitable polymer. In the example shown, reed 130 has a circular or oval entrapped edge 134 and a straight, free edge 136. Also, in the example shown, reed 132 has a circular or oval entrapped edge 138 and a non-uniform, free edge 140 having a plurality of valleys 142 and at least one peak 144. The diaphragm holder 104 entraps and engages the entrapped edges 134, 138 as described above.

As exhaled air travels along the diaphragm 106, the free edges 136 and 140 flap back and forth and vibrate. The vibration of the free edges 136, 140 generates a sound. This sound simulates or resembles the vocal sound of an animal, such as a turkey, elk or other animal. It should be appreciated that the free edges 136, 140 of the diaphragm 106 can have different shapes for generating different types of sounds which resemble the vocal outputs of different types of animals. For example, various shapes of the valleys 142 and peak 144 can cause different levels of air disturbances which, in turn, can cause different sound pitches and sound characteristics. In another embodiment, the diaphragm 106 is replaced with any suitable type of sound generator operable to produce sound for attracting animals.

Referring to FIG. 3, the palate conformer 107 is carried by the mouth engager 102. The palate conformer 107 is sandwiched between the interior halves 112, 114 of the mouth engager 102 at the rear section 145 of the game call assembly 100. In an embodiment, the adhesive of the interior halves 112, 114 secures the palate conformer 107 at a suitable location behind, and centered with, the holding tab 122 of the frame 116.

In an embodiment illustrated in FIGS. 3 and 6-7, the palate conformer 107 has a body 155, a plurality of ends 156, a top 146, a bottom 150, a front sidewall 152 and a back sidewall 154 (FIG. 3). As shown in FIG. 3, the front sidewall 152 has a concave, arc shape, and the back sidewall 154 has a convex, arc shape. The body 155 has a plurality of body segments 151, wherein each body segment 151 extends to one of the ends 156. In use, the user presses the palate conformer 107 onto the roof of the user's mouth. Because of the pliable or ductile characteristics of the palate conformer 107, the palate conformer 107 converts or transforms from: (a) an initial or first shape 109 in which the body 155 and ends 156 are located on a first axis 111; to (b) a final, second or custom shape 113 in which the body 155 is located on first axis 111 and the ends 156 are located on a lower, second axis 115. Accordingly, the palate conformer 107 changes to a custom-fit, convex shape that corresponds to the unique shape of the user's concave mouth roof and palate.

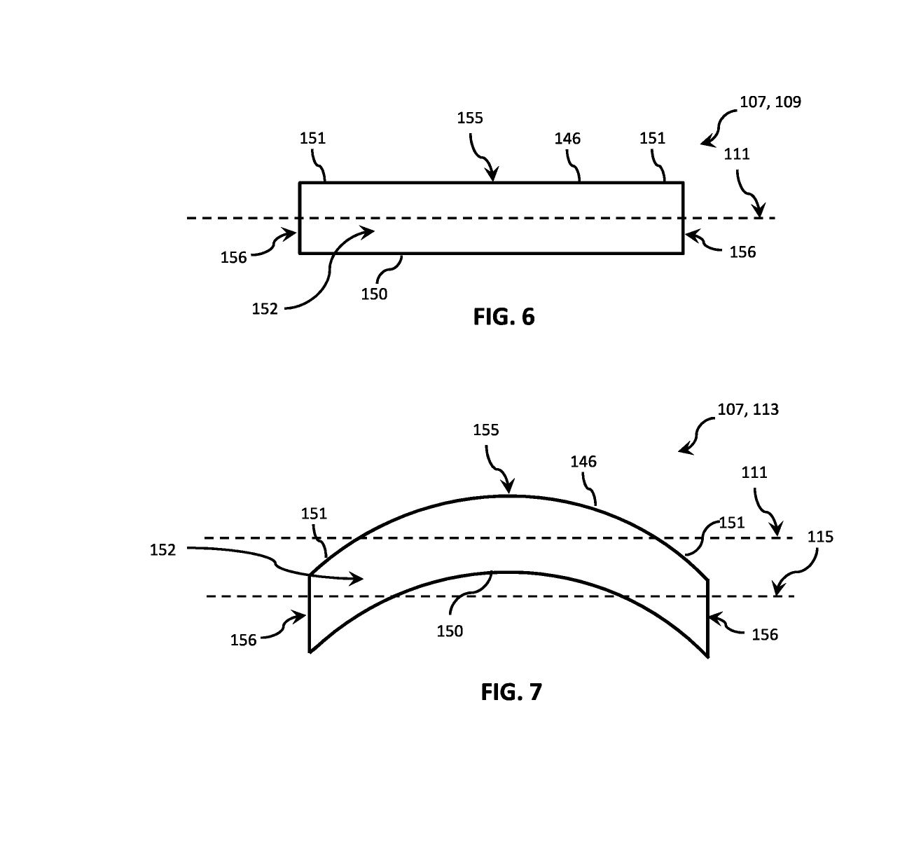

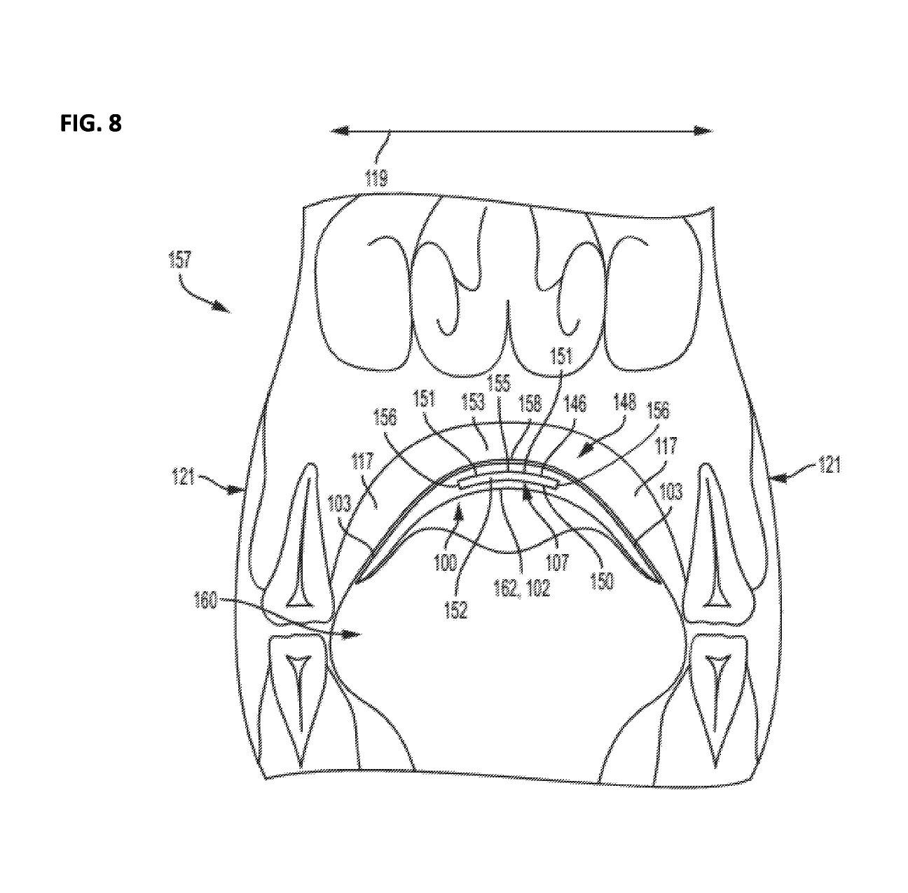

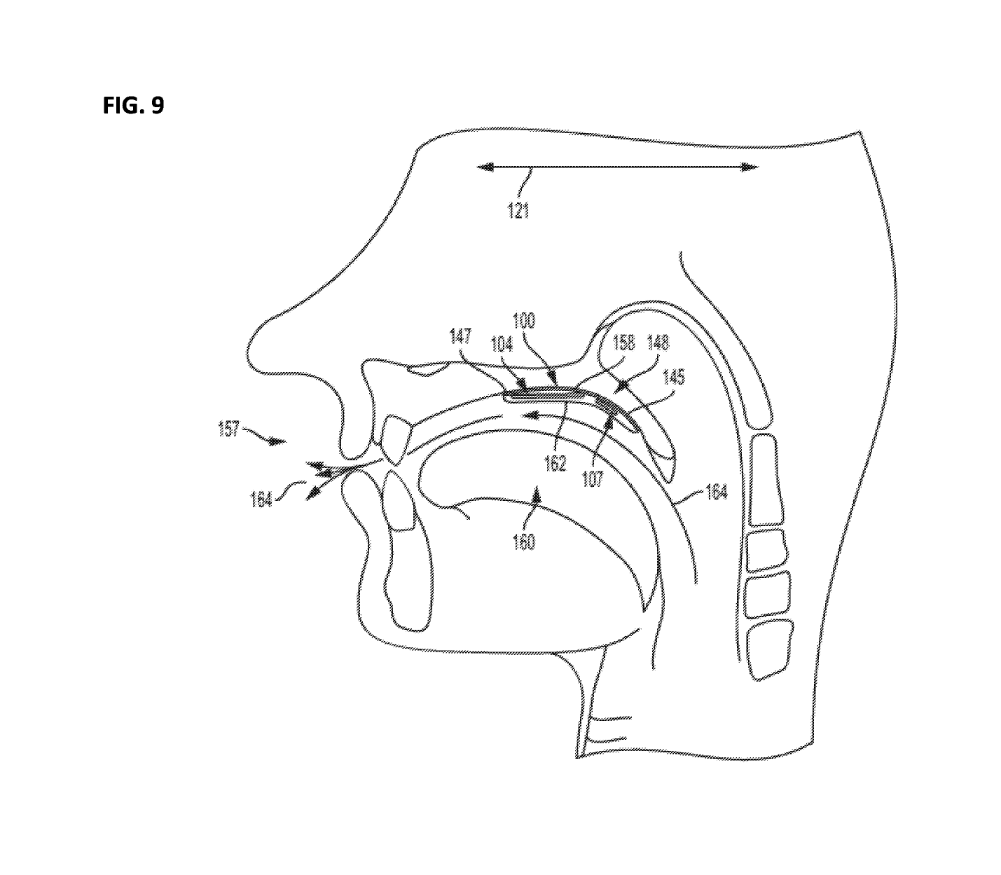

As illustrated in FIGS. 8-9, the top 146 of the palate conformer 107 is configured to be pressed against the roof of the mouth or the concave palate 148. In the custom shape 113 (FIG. 7), the palate conformer 107 has curved or arc-shaped body segments 151. As described above, the palate conformer 107 is bendable and has a ductile or malleable characteristic. By applying a tongue force or hand force, the user can change the shape of the palate conformer 107 from its original, flat shape 109 (FIGS. 3 and 6) to a custom, bent shape 113 (FIGS. 7-9). As described below, the bendable characteristic of the palate conformer 107 enables the user to conform the game call assembly 100 to the unique shape of the user's concave palate 148. The palate conformer 107 then retains the bent shape 113 for suitable operation of the game call assembly 100 as described below.

With continued reference to FIGS. 8-9, the user inserts the game call assembly 100 into the user's mouth 157. In doing so, the user places the game call top 158 (FIGS. 5 and 8-9) so that it engages the palate 148. The user presses his/her tunnel-shaped tongue 160 against the game call bottom 162 (FIGS. 1, 5 and 8-9). Upon insertion, there could be one or more air gaps or air passages between the user's palate 148 and the game call top 158. This can be caused by the unique size and shape of the user's palate 148. As a result, the air gaps and air passages can impair or eliminate the animal call functionality of the game call assembly 100. For example, these attraction-destructive air passages can cause a hissing sound that repels, rather than attracts, the targeted animal. To avoid this problem, the user can use his/her tongue 160 or fingers to firmly press the rear section 145 (FIGS. 3 and 9) of the game call assembly 100 against the user's palate 148. In doing so, the user applies a force to the mouth engager 102 (FIG. 3) which is transmitted to the bottom 150 (FIG. 8) of the palate conformer 107. This force pushes the palate conformer 107 into the concave recess of the user's palate 148. Due to this force, the palate conformer 107 bends from its original, flat shape 109 (FIGS. 3 and 6) to a custom, bent shape 113 (FIGS. 7-9). The bent shape 113 is customized to the particular shape and size of the user's concave palate 148. Due to this bent shape 113 of the palate conformer 107, the top 146 of the palate conformer 107 conforms to the user's unique palate 148 and is indirectly engaged with the palate 148 separated by the layer of the game call top 158.

In addition, since the mouth engager 102 (FIG. 3) is flexible, the mouth engager 102 flexes or bends at the palate sides 117 (FIG. 8) of the user's palate 148. Therefore, at least the rear section 145 (FIG. 9) of the mouth engager 102 is engaged with or sealed to the palate 148 at the palate sides 117 and is also engaged with or sealed at the palate central region 153 (FIG. 8). This engagement or sealing and conformity with the user's uniquely-shaped palate 148 prevents, minimizes or otherwise reduces air gaps and air passages between the user's palate 148 and the game call top 158. Consequently, the game call assembly 100 is operable to produce game call sounds without the undesirable, extraneous sounds not caused by the diaphragm 106.

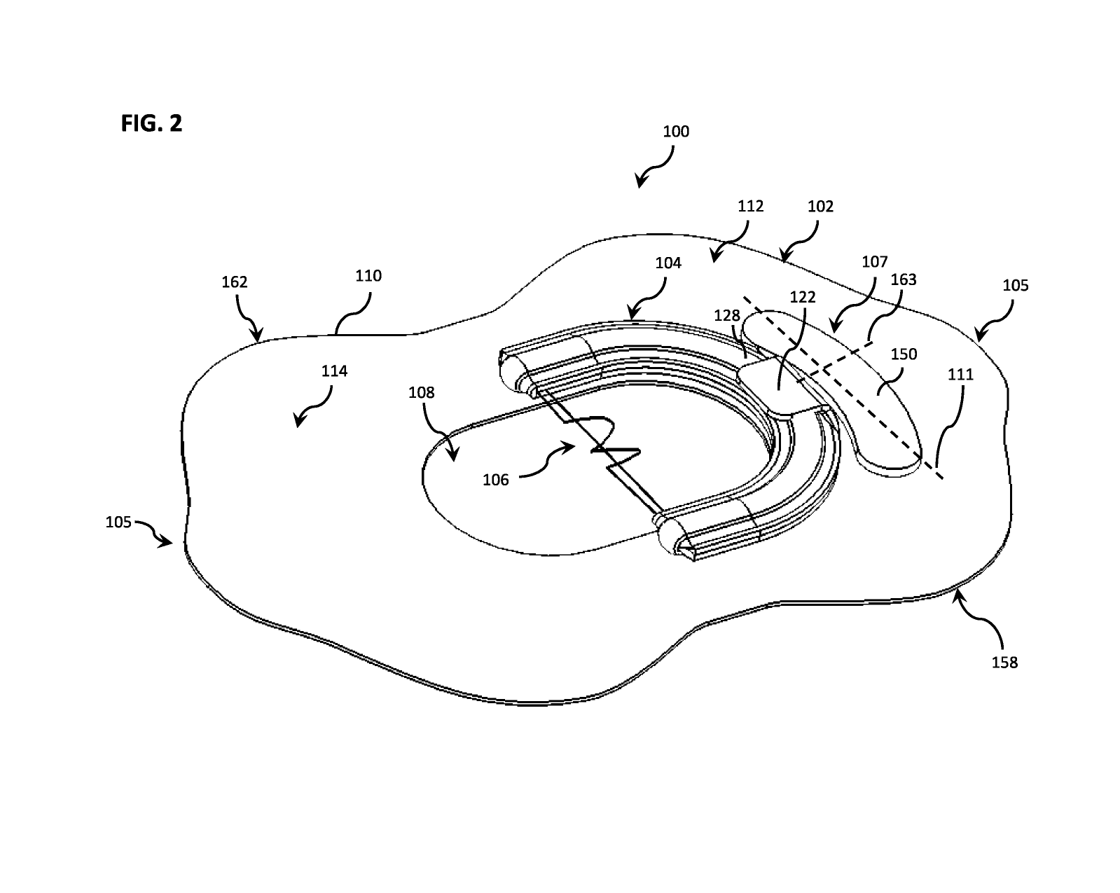

Referring to FIGS. 2 and 7-9, in an embodiment, the palate conformer 107 is bendable in a plurality of planes. The user can bend the palate conformer 107 along its longitudinal axis 111 (FIG. 2). This enables the palate conformer 107 to mate with the right-to-left arching of the user's palate 148 (arching in the right-left directions 119), as illustrated in FIG. 8. When the palate conformer 107 is inserted in the user's mouth, the axis 111 extends through both cheeks 121 of the user, as illustrated in FIG. 8. Also, the user can bend the palate conformer 107 along its short axis 163 (FIG. 2). This enables the palate conformer 107 to mate with the front-to-back arching of the user's palate 148 (arching in the fore-aft directions 121), as illustrated in FIG. 9.

Referring to FIG. 9, in operation, the palate conformer 107 enables the user to both customize and conform the game call assembly 100 to the unique shape of his/her palate 148. In use, the exhaled airflow 164 travels along the game call bottom 162 and onto the diaphragm 106. The user presses his/her tunnel-shaped tongue 160 against the edges 110 (FIG. 1) of the game call assembly 100. Note that, in FIG. 9, the tongue 160 is shown disengaged for illustration purposes. The airflow 164 causes the diaphragm 106 (FIG. 1) to vibrate. The vibration generates a game call sound to attract animals. Due to the custom-shaped palate conformer 107, at least the rear section 145 (FIGS. 1 and 3) of the game call top 158 is engaged with or sealed to the palate 148, as described above. It should be understood that even if there are air gaps between the front section 147 (FIGS. 1 and 9) of the mouth engager 102 and the user's palate 148, the airflow 164 will not reach such air gaps because of the sealing at the rear section 145. This sealing prevents or inhibits the flow of attraction-destructive airflow between the user's palate 148 and the game call top 158. As a result, the game call assembly 100 exhibits improved sound generating functionality for users having mouths of different sizes and shapes. The game call assembly 100 also provides enhanced, custom fit for improved ergonomics, improved ease of use, and reduction in choking or gagging hazards.

In an embodiment, the diaphragm holder 104 and palate conformer 107 are each constructed of a suitable bendable, flexible, malleable, ductile or deformable material. This material, in an embodiment, is configured to undergo plastic deformation in response to a force without fracturing. When the force is removed, the material retains its new shape when not subject to further forces. Examples of this type of material include, without limitation, aluminum, copper, iron, tin and steel. It should be appreciated, however, that the diaphragm holder 104 and palate conformer 107 can each be constructed of any suitable deformable material, including, but not limited, to metallic, plastic and polymeric materials.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. A game call assembly comprising:
a mouth engager comprising a top and a bottom;
a diaphragm holder coupled to the mouth engager;
a diaphragm held by the diaphragm holder; and
a palate conformer supported by the mouth engager, wherein the palate conformer comprises a body, a plurality of ends, and a malleable characteristic,
wherein, due to the malleable characteristic, the palate conformer is configured to be changed from a first form to a second form,
wherein, in the first form, the body and ends are positioned along a first axis, wherein the first axis extends through a plurality of cheeks of a user when the palate conformer is inserted into a mouth of the user,
wherein, in the second form, the body is at least partially positioned along the first axis, and the ends are positioned on one or more axes other than the first axis, wherein the one or more axes extend through the cheeks of the user when the palate conformer is inserted into the mouth of the user,
wherein when the body is in the second form, a portion of the mouth engager is configured to conform to, and be engaged with, a palate of the user's mouth so as to inhibit air from traveling between the palate and the top of the mouth engager so as to reduce a production of a sound not generated by the diaphragm.

2. The game call assembly claim 1, wherein the mouth engager comprises a plurality of flexible layers.

3. The game call assembly claim 1, wherein the diaphragm holder comprises a frame.

4. The game call assembly claim 3, wherein the frame comprises a plurality of bend notches.

5. The game call assembly claim 4, wherein the frame comprises a holding tab.

6. The game call assembly claim 1, wherein the diaphragm comprises a first reed and a second reed at least partially lying under the first reed.

7. The game call assembly claim 6, wherein one of the first and second reeds comprises an edge, wherein the edge comprises a plurality of valleys and at least one peak between the valleys.

8. The game call assembly claim 1, wherein the palate conformer comprises a front sidewall comprising an arc shape.

9. The game call assembly claim 8, wherein the palate conformer comprises a back sidewall comprising an arc shape.

10. The game call assembly claim 8, wherein the malleable characteristic comprises a ductile characteristic.

11. A game call assembly comprising:
a mouth engager;
a sound generator coupled to the mouth engager; and
a palate conformer supported by the mouth engager, wherein the palate conformer comprises a deformable characteristic.

12. The game call assembly of claim 11, wherein:
the sound generator comprises a diaphragm; and
the mouth engager comprises a top and a bottom.

13. The game call assembly of claim 12, wherein the palate conformer comprises a body and a plurality of ends,
wherein, due to the deformable characteristic, the palate conformer is configured to be changed from a first form to a second form,
wherein, in the first form, the body and ends are positioned along a first axis, wherein the first axis extends through a plurality of cheeks of a user when the palate conformer is inserted into a mouth of the user,
wherein, in the second form, the body is at least partially positioned along the first axis, and the ends are positioned on one or more axes other than the first axis, wherein the one or more axes extend through the cheeks of the user when the palate conformer is inserted into the mouth of the user,
wherein when the body is in the second form, a portion of the mouth engager is configured to conform to, and be engaged with, a palate of the user's mouth so as to inhibit air from traveling between the palate and the top of the mouth engager so as to reduce a production of a sound not generated by the diaphragm.

14. The game call assembly claim 11, wherein the mouth engager comprises a plurality of flexible layers.

15. The game call assembly claim 11, comprising a frame configured to hold the sound generator.

16. The game call assembly claim 15, wherein the frame comprises a plurality of bend notches.

17. A method for manufacturing a game call assembly, the method comprising:
providing a mouth engager;
coupling a sound generator to the mouth engager;
providing a deformable palate conformer; and
coupling the deformable palate conformer to a rear portion of the mouth engager,
wherein the deformable palate conformer is configured to be deformed so as to conform to a concave shape of a palate of a user.

18. The method of claim 17, wherein the sound generator comprises a diaphragm.

19. The method of claim 18, wherein:
the mouth engager comprises a top and a bottom;
the palate conformer comprises a body and a plurality of ends;
the palate conformer is configured to bend, in response to a force, from a first form to a second form;
in the first form, the body and ends are positioned along a first axis, wherein the first axis extends through a plurality of cheeks of a user when the palate conformer is inserted into a mouth of the user;
in the second form, the body is at least partially positioned along the first axis, and the ends are positioned on one or more axes other than the first axis, wherein the one or more axes extend through the cheeks of the user when the palate conformer is inserted into the mouth of the user; and
when the body is in the second form, a portion of the mouth engager is configured to conform to, and be engaged with, a palate of the user's mouth so as to inhibit air from traveling between the palate and the top of the mouth engager so as to reduce a production of a sound not generated by the diaphragm.

20. The method of claim 19, wherein the mouth engager comprises a plurality of flexible layers that house the palate conformer.
